(19) United States
(12) Patent Application Publication
(10) Pub. No.: US 2007/0115782 A1
(43) Pub. Date: May 24, 2007

(54) Optical pick-up unit

(75) Inventors: Ole Klembt Andersen, Eindhoven (NL); Robert Frans Maria Hendriks, Eindhoven (NL); Alexander Marc Van Der Lee, Eindhoven (NL); Jan Evert Van Der Werf, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,649

(22) PCT Filed: Dec. 13, 2004
(86) PCT No.: PCT/IB04/04176

§ 371 Date: Jun. 20, 2006

(30) Foreign Application Priority Data
Dec. 23, 2003 (EP) 03300289.0

(51) Int. Cl. G11B 7/00

(52) U.S. Cl. 369/53.23

(57) ABSTRACT

A pick-up unit, an optical drive comprising such a pick-up unit, and a method of generating error-signals are described. Light reflected from an information carrier is injected into one or more VCSELs. The spatial intensity distribution of the emission from the VCSEL(s) is used for the generation of error signals in an optical pick-up unit. Alternatively, the relative timing for the switching of individual lasers of an array of VCSELs is used for the detection of error signals.

### TECHNICAL FIELD OF THE INVENTION

The present invention relates to an optical pick-up unit. More particularly, the invention relates to a pick-up unit for reading information from an optical information carrier, said unit comprising a non-linear element for improving the read-out signal. The invention also relates to an optical drive comprising such an optical pick-up unit, and to a method of generating error-signals.

### BACKGROUND OF THE INVENTION

When reading information from an optical information carrier by illuminating said carrier with light, and then detecting the light reflected from the surface of the carrier, an improved read-out signal can be obtained by using a non-linear element for the detection. One such non-linear element that can be used for the detection is a vertical-cavity surface-emitting laser (VCSEL).

However, when using a non-linear element in the detection path of an optical pick-up unit, it is not clear how to generate error signals. When digitization around the slicer level is performed optically, as with a non-linear optical element, no gradual s-curve can be obtained from the detected signals.

WO 01/26102 discloses a VCSEL-based optical pickup and servo control device, wherein a plurality of VCSELs are used for emitting laser beams and a plurality of detectors are used for detection and generation of error signals. While this referenced document describes a number of methods for generating error signals, these methods cannot be used when one or more VCSELs are used in the detection branch of an optical drive for enhancing the read-out signal.

Thus, there is a general problem in the prior art relating to the generating of error signals when a non-linear element such as a VCSEL is used in the detection branch of an optical pick-up for enhancing the read-out signal.

### SUMMARY OF THE INVENTION

Therefore, it is an object of the present invention to provide an optical pick-up unit employing a VCSEL as a non-linear element for the detection, in which error signals can be generated.

According to the present invention, it is proposed both how to generate focus-error signals, and how to generate push-pull tracking-error signals when a VCSEL is used in the detection branch of the optical pick-up unit.

The present invention is based on a recognition that either of two different approaches can be used for generating the error signals. Firstly, a different property than that used for digitization could be employed. For example, if polarization switching is used for detecting marks on the information carrier, then the spatial distribution of light emitted by the VCSEL could be employed for the generation of error signals. Secondly, a property that is robust under digitization could be employed. For example, the phase difference of the read-out signal between four different quadrants of a detector pupil could be employed.

According to a first aspect of the present invention, it is proposed to use the spatial distribution of the light emitted by the VCSEL for the generation of error signals.

According to a second aspect of the present invention, it is proposed to use the phase difference between different parts of the optical signal for the generation of error signals, by directing the light reflected from the information carrier onto an array of VCSELs and determining the relative timing of switching for the lasers of the array. Error signals are then generated based on said determined relative timing.

Hence, the idea underlying the present invention is the use of spatial properties of the light emitted by the VCSEL(s) as a consequence of injection for the generation of error signals. The spatial properties of light emitted from a single VCSEL can be analyzed by means of a sectored detector arranged adjacent said VCSEL. Alternatively, the light reflected from the information carrier could be injected into a plurality of VCSELs arranged in an array, and the relative timing of switching for lasers in the array can be the basis for generating error signals.

### BRIEF DESCRIPTION OF THE DRAWINGS

In the following detailed description of the invention, reference will be made to the accompanying drawings, in which:

FIG. 1 schematically shows an optical pick-up unit in which the present invention can be implemented;

FIG. 2 shows near-field radiation patterns of a typical 15 μm square-type VCSEL;

FIG. 3 is an illustration of focus tracking by the use of an astigmatic injection beam and a VCSEL in the first-order transverse mode;

FIG. 4 is an illustration of focus tracking by the use of an annular lens, where the VCSEL is in the first or second-order transverse mode;

FIG. 5 is an illustration of radial error tracking signal generation due to a shift of the “center of gravity” for the VCSEL output caused by a push-pull asymmetry in the injected light;

FIG. 6 shows an arrangement of VCSELs for generation of error signals from timing difference (or phase difference) between the individual VCSELs; and

FIG. 7 is an illustration of how a defocus affects the signals falling on the arrangement shown in FIG. 6.

### DETAILED DESCRIPTION OF THE INVENTION

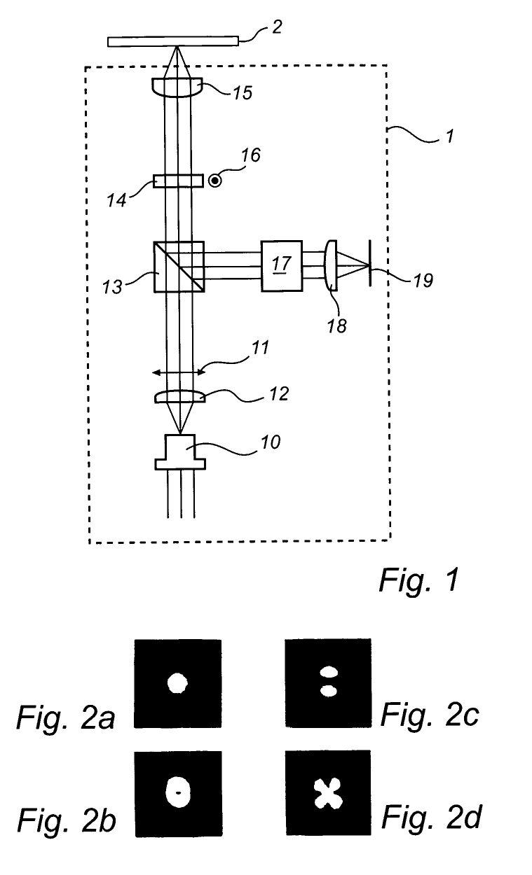

By way of introduction, an optical pick-up unit in which the present invention can be implemented will be described with reference to FIG. 1 of the drawings.

The constituents of the optical pick-up unit are schematically shown within dashed lines, and the unit is generally indicated by the reference numeral 1. The unit 1 comprises a light source 10, typically a diode laser, for illuminating an information carrier 2. The light source 10 emits linearly polarized light, as indicated by the symbol 11. The beam of linearly polarized light from the light source is collimated by means of a collimating lens 12 and passed through a polarizing beam splitter 13. After passage of the beam splitter 13, the beam passes a quarter-wave-plate (λ/4-plate) 14 and is subsequently focused on the information carrier 2 by means of an objective lens 15. The beam of light is then reflected from the information carrier 2 and thereby gets a modulation containing the read-out information from the information carrier 2. The reflected light passes again through the objective lens 15 to become collimated, and then continues towards the beam splitter 13 and passes the quarter-wave-plate 14 a second time. By appropriate adjustment of the quarter-wave-plate 14, the linear polarization of the beam is rotated by 90° by the two passages through the wave-plate. Then the beam, now having a polarization that is orthogonal to the original polarization as indicated by the symbol 16, is reflected by the beam-splitter towards a detection branch of the pick-up unit. The detection branch comprises a non-linear element 17 for enhancing the read-out signal, and a lens 18 for focusing the optical signal on a detector or array of detectors 19.

The non-linear element 17 in the detection branch could be of a number of different implementations. According to this invention, the element 17 comprises a vertical-cavity surface-emitting laser (VCSEL). Light reflected from the information carrier 2 and deflected by the beam-splitter 13 is injected into the VCSEL in order to control the properties of said VCSEL.

A first way of employing the VCSEL for enhancing the read-out signal is what we call here polarization-switching. This is based on using the injected light to increase the gain for a polarization mode that is orthogonal to the free-running (i.e. without injection) polarization mode of the VCSEL, such that a switch in polarization mode is obtained for the VCSEL when the injected light is sufficiently high in power. By passing the emission from the VCSEL through a polarizer, it can be defected out of hand whether such polarization-switching has occurred or not. Hence, in this case, the non-linear element 17 also comprises a polarizer (not shown), which blocks the emission from the VCSEL in its free-running state, but does pass light of the orthogonal polarization direction. Therefore, any light detected by the detector 19 is due to a polarization-switch in the VCSEL. In this way, marks of high reflection on the information carrier (manifested in a reflected beam of comparatively high power being injected into the VCSEL) can be detected by the output from the VCSEL being switched to a polarization that can reach the detectors.

A second way of employing a VCSEL for enhancing the read-out signal is here called threshold-switching. In this case, the VCSEL is driven just below its lasing threshold such that there is no laser emission when no light is injected into the VCSEL. When a sufficient amount of light is injected into the VCSEL, the gain increases to above the lasing threshold, and the VCSEL starts to emit light. Hence, by detecting any laser emission from the VCSEL, it can be determined whether a mark of high or low reflection is being read from the information carrier 2.

Common to both above ways of using the VCSEL to improve the optical read-out signal is that a certain level of injected light is required in order to achieve a switching of the VCSEL operation. If the amount of injected light is low (i.e. if a mark of low reflectivity is being read from the information carrier), the operation of the VCSEL will not be switched. If polarization-switching is employed, the VCSEL will still emit in its free-running polarization mode. If threshold-switching is employed, the gain of the VCSEL will still be below the lasing threshold. Hence, substantially no light from the VCSEL will reach the detector unless a mark of high reflection is currently being read from the information carrier.

As soon as the amount of injected light is sufficiently high, the VCSEL will switch as described above. This switch is then detected, and the information contained in the injected light (modulated by the information carrier) can be extracted. One very beneficial characteristic of this detection scheme is that the power emitted by the VCSEL is typically much higher than the power of the injected light. Hence, the read-out is improved and the signal-to-noise ratio for the read-out is increased. Moreover, using a VCSEL for detection according to what has been described above reduces the detection to a simple check of whether the VCSEL has switched state or not. This, of course, gives an excellent signal-to-noise ratio.

Now, the question is how to generate error signals from the read-out when using a VCSEL according to above. Any error information contained in the light reflected from the information carrier is conventionally lost when this light is injected into the VCSEL.

FIG. 2 shows typical near-field emission patterns from a 15 μm square-type VCSEL. FIG. 2(a) shows emission in the TEM₀₀ mode, FIG. 2(b) shows emission in the TEM₀₁* mode, FIG. 2(c) shows emission in the TEM₁₀ mode, and FIG. 2(d) shows the simultaneous emission in TEM₀₀ and TEM₁₁ modes. The spatial intensity distribution of the light emitted by a VCSEL is typically a function of the current drawn through the device. In the case shown in FIG. 2, the intensity distribution is measured at the surface of the VCSEL. However, the specific intensity distributions shown in the Figure are conserved when the emitted light propagates through space.

Therefore, a detector placed in front of the VCSEL would detect a similar intensity distribution. In the cases shown in FIGS. 2(a)-(c), the VCSEL is lasing on a single transverse mode. In FIG. 2(d), the VCSEL is simultaneously lasing on two transverse modes (the TEM₀₀ and the TEM₁₁ modes). The number of possible transverse modes depends on the surface area of the VCSEL.

The transverse mode emitted by the VCSEL can also be influenced by the intensity distribution of light injected into the VCSEL. This is the basis for the generation of error signals according to the first aspect of the present invention. In this context, it should be noted that injection is equivalent to an increased gain in the VCSEL.

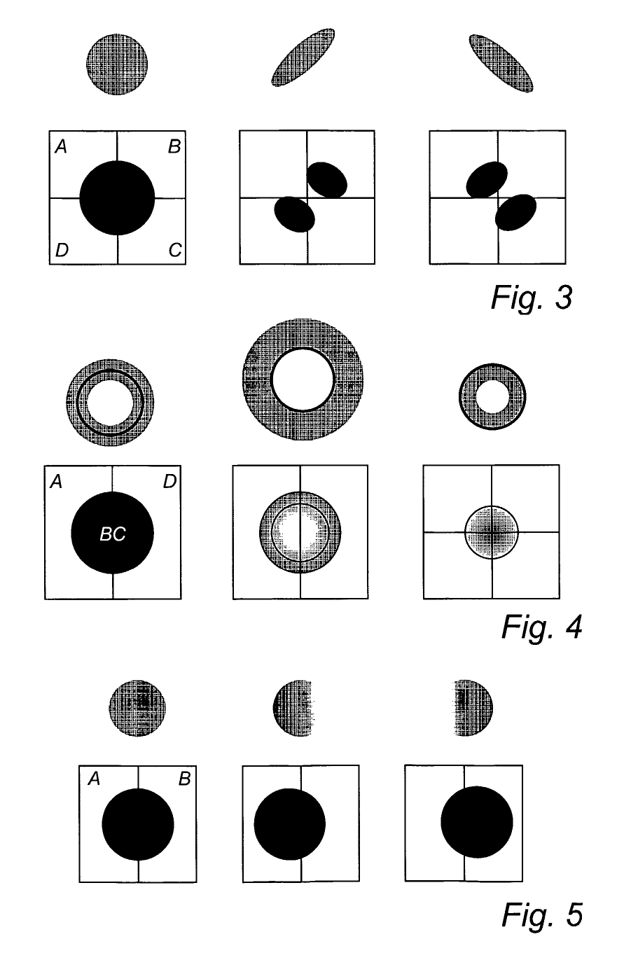

One embodiment of the present invention for the detection of focus error will now be described with reference to FIG. 3, which illustrates astigmatic focus tracking using a VCSEL in the first-order transverse mode. The upper part of the figure shows the spatial profiles for the injected light. The left picture shows the injected profile when in focus, and the middle and right pictures show the injected profile when above and below focus. The lower row shows the output profiles of the VCSEL due to the corresponding injected profile. For illustrative purposes, the emission from the VCSEL as shown in the figure has been superimposed upon a standard four-quadrant detector.

As shown in the left picture in FIG. 3, when the device is in focus, the intensity distribution of the injected light matches the TEM₀₀ mode of the VCSEL. Hence, in-focus injection into the VCSEL results in symmetrical emission. However, when the device is out of focus, the injected light will have an astigmatic shape. The VCSEL mode matching such astigmatic injection will be the TEM₁₀ modes, with an orientation similar to that of the astigmatic injection. Therefore, in the out-of-focus situation, the four quadrants of the detector will receive different amounts of light. In this way, a normalized focus-error signal (NFES) can be defined as
NFES=(A+C−D−B)/(A+B+C+D),
where A, B, C and D are the signals from the four respective quadrants of the detector, as schematically indicated in the figure.

It should be noted that the information read-out from the information carrier is made by means of the intensity/polarization of the VCSEL output, while the error signals are generated by means of the spatial distribution of the VCSEL output.

The error-signal generation described with reference to FIG. 3 relies on the injected light to have an astigmatic profile when out of focus. This is typically obtained by means of an astigmatic lens.

In another embodiment, a focus-error signal is generated by means of an annular lens, as illustrated in FIG. 4. For example, this is the case when the laser used for illuminating the information carrier is a VCSEL itself.

In the embodiment illustrated in FIG. 4, the detector is divided into detection areas differently than in the example above (where four quadrants were used). In this case, the detector is divided into a left rectangle and a right rectangle together forming a square, and with a left semi-circle and a right semi-circle at the center of the square. Again, the detector signals from the four parts of the detector are labeled A, B, C and D, as shown in the figure.

The spatial intensity-distributions injected into the VCSEL are shown in the upper row of FIG. 4. The intensity distributions are characteristic of an annular lens. The in-focus situation is shown in the left picture. Injection of such an intensity distribution into the VCSEL results in an emission from the VCSEL, which is a combination of the TEM₀₀ and the TEM₀₁* modes (compare FIG. 2). When the device is in focus, this will result in equal amounts of light on all four parts (A, B, C, D) of the detector, as illustrated in the bottom-left picture of FIG. 4. When the system is above focus, the intensity distribution of the injected light will be as shown in the middle picture. The corresponding mode of the VCSEL is the one for which the majority of the emitted intensity is away from the center, namely the TEM₀₁* mode.

Hence, more intensity will fall on detector parts A and D, compared to detector parts B and C. Below focus, as illustrated in the right pictures, the mode of the VCSEL is the one for which the majority of the emitted intensity is close to the center, namely the TEM₀₀ mode. In this case, more light will fall upon the detector parts B and C than upon A and D. So, the normalized focus-error signal will be given by:
NFES=(A+D−B−C)/(A+B+C+D),
where A, B, C and D are the signals from the respective detector parts similar to the situation described above.

In another embodiment of the present invention, the spatial distribution of the emission from the VCSEL is used for generating radial push-pull tracking-error signals. This is illustrated in FIG. 5.

If the pick-up unit is out of tracking, there will be an asymmetry in the light reflected from the information carrier. This can be employed for the generation of a tracking-error signal. The push-pull asymmetry of the injected light introduces an asymmetric gain in the VCSEL, which in turn alters the ratio of the TEM₀₁ and the TEM₀₀ output components of the VCSEL. The effect of this will be a displacement of the spot on the detectors.

In order to have this principle work properly, the two transverse modes TEM₀₁ and TEM₀₀ of the VCSEL should be phase-locked, which normally means that the eigen-frequencies of the two modes should be nearly the same. For the generation of the push-pull signal, only two detector parts are required, as indicated in the figure. A feedback loop from the detector could be used for controlling tracking of the pick-up unit.

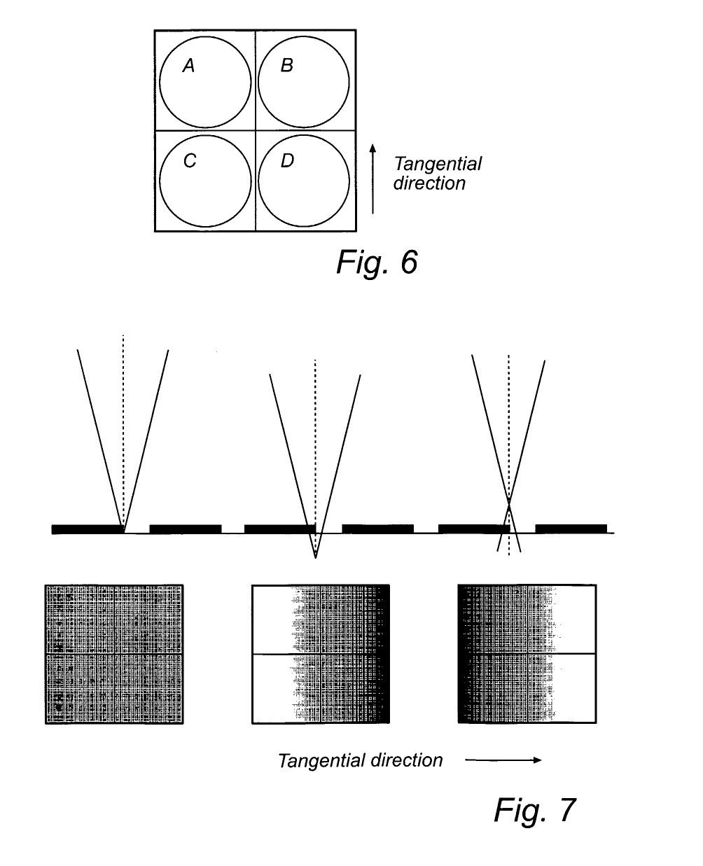

In yet another embodiment of the invention, more than one VCSEL are used. An example of this is schematically shown in FIG. 6, where four VCSELs are shown to generate a relative timing-error (phase-difference) signal. In this case, one VCSEL is arranged in front of each quadrant of the detector, and the timing of the switch of each VCSEL is used for the generation of the error signal. As for the cases described above, each VCSEL is switched when a sufficient amount of light is injected into same. A focus-error signal can be established from the difference in switching time between the VCSELs in the “tangential” direction (see the figure). It should be noted that each VCSEL switch independently of the others.

The detection of a focus error is illustrated in FIG. 7. If the pick-up unit is in focus, then all four VCSELs of FIG. 6 will switch simultaneously when the center of the illumination spot hits a mark on the information carrier, as illustrated in the left picture of FIG. 7. If the pick-up unit is out of focus, one side of the detector will be illuminated before the other (in effect, two adjacent VCSELs will switch before the other two) when the center of the illumination spot hits a mark on the information carrier. Hence, by taking into account the rotation direction of the information carrier, a focus-error signal can be derived from the phase difference between (A+B) and (C+D) using the definition of tangential direction according to FIGS. 6 and 7.

It is also possible to generate a tracking-error signal using this embodiment. In such case, the phase difference is determined between (A+D) and (B+C) instead, whereby a push-pull asymmetry in the beam reflected from the information carrier can be detected.

In conclusion, the use of the spatial intensity distribution from a vertical-cavity surface-emitting laser for the generation of error signals has been described. Also, the use of an array of VCSELs for the generation of error signals has been described.

1. An optical pick-up unit (1) for reading information from an optical information carrier (2), the unit comprising:
a light source (10) for illuminating the information carrier (2);
an optical system for injecting light reflected from the information carrier (2) into at least one vertical-cavity surface-emitting laser (17); and
means (19) for detecting the spatial characteristics of the output from the or each vertical-cavity surface-emitting laser and to thereby generate error signals for the optical pick-up unit.

2. An optical pick-up unit as claimed in claim 1, wherein said means (19) comprises a detector having at least two separate detection regions, and wherein the pick-up is arranged to generate a push-pull tracking-error signal by comparing the signals from said at least two separate detection regions.

3. An optical pick-up unit as claimed in claim 1, wherein said means (19) comprises a four-quadrant detector, and wherein the pick-up is arranged to generate a focus-error signal by comparing the signals from the four quadrants of the detector.

4. An optical pick-up unit as claimed in claim 1, wherein said means (19) comprises two semi-circular central detector regions and two rectangular outer detector regions and said light source (10) for illuminating the information carrier is a light source having circular symmetric output, and wherein the pick-up is arranged to generate a focus-error signal by comparing the signals from said detector regions.

5. An optical pick-up unit as claimed in claim 1, comprising an array of vertical-cavity surface-emitting lasers, wherein said means (19) comprises a corresponding array of detectors each of which is arranged adjacent to a respective one of said lasers.

6. An optical drive comprising a pick-up unit according to claim 1.

7. A method of generating an error signal when reading information from an optical information carrier, the method comprising the steps of:
directing light onto the information carrier;
injecting light reflected from the information carrier into at least one vertical-cavity surface-emitting laser;
analyzing the spatial characteristics of the output from the or each vertical-cavity surface-emitting laser; and
generating an error signal based on the spatial characteristics of said output from the or each vertical-cavity surface-emitting laser.

8. An optical pick-up unit (1) for reading information from an optical information carrier (2), the unit comprising:
a light source (10) for illuminating the information carrier (2);
an optical system for directing light reflected from the information carrier (2) onto an array of vertical-cavity surface-emitting lasers (17); and
means (19) for determining the relative timing of switching for the lasers of the array caused by the injection of light, and for generating error signals for the optical pick-up unit based on said relative timing.

9. An optical pick-up unit as claimed in claim 8, wherein said array is a two-by-two array of lasers.

10. An optical pick-up unit as claimed in claim 8 or 9, wherein the means (19) is arranged to generate a focus-error signal by comparing the relative timing of at least two adjacent lasers of the array.

11. An optical pick-up unit as claimed in claim 8-or 9, wherein the means (19) is arranged to generate a push-pull tracking-error signal by comparing the relative timing of at least two non-adjacent lasers of the array.

12. An optical drive comprising a pick-up unit according to claim 8.

13. A method of generating an error signal when reading information from an optical information carrier, the method comprising the steps of:
directing light onto the information carrier;
directing light reflected from the information carrier onto an array of vertical-cavity surface-emitting lasers to inject said reflected light into the laser of the array;
determining the relative timing of switching for the lasers of the array; and
generating an error signal based on the determined relative timing.
